(19) United States
(12) Patent Application Publication
(10) Pub. No.: US 2025/0271841 A1
(43) Pub. Date: Aug. 28, 2025

(54) Scheduling of Recipe-Driven Manufacturing

(71) Applicants: Moshe BenBassat, Tzur Moshe (IL); Avner Ben-Bassat, Even Yehuda (IL); David Tweeto, Jerusalem (IL); Eduard Ruvinsky, Petah Tikva (IL); Gil Cooper, Ganei Tikva (IL); Anat Kanner Kalka, Ness Ziona (IL)

(72) Inventors: Moshe BenBassat, Tzur Moshe (IL); Avner Ben-Bassat, Even Yehuda (IL); David Tweeto, Jerusalem (IL); Eduard Ruvinsky, Petah Tikva (IL); Gil Cooper, Ganei Tikva (IL); Anat Kanner Kalka, Ness Ziona (IL)

(73) Assignee: Plataine Ltd., Petah Tikva (IL)

(21) Appl. No.: 19/058,006

(22) Filed: Feb. 20, 2025

Related U.S. Application Data
(60) Provisional application No. 63/558,664, filed on Feb. 28, 2024.

(51) Int. Cl. G05B 19/418

(52) U.S. Cl. CPC G05B 19/41865; G05B 2219/32283; G05B 2219/40499

(57) ABSTRACT

A method, system and computer program product then method comprising: obtaining a work order where at least one part is to undergo a recipe-driven process to be executed by a device, according to a recipe; obtaining the recipe upon which the recipe-driven process is to be executed; obtaining a plurality of constraints for the recipe-driven process associated with the work order, the plurality of constraints relating at least to an area or volume of the device and area or volume of the at least one part; generating a schedule for processing the at least one part by the recipe-driven process in accordance with the plurality of constraints; prior to execution of the recipe-driven process, receiving through an interface an automated notification of an event prohibiting execution of the recipe-driven process; and regenerating an updated schedule for preparing the work order, including the recipe-driven process.

### CROSS-REFERENCE TO RELATED APPLICATION

This application claims the benefit of provisional patent application No. 63/558,664, entitled “Comprehensive Multi-Dimensional AI-Driven Solution for Scheduling of Recipe-Driven Manufacturing Processes” filed Feb. 28, 2024, which is hereby incorporated by reference in its entirety.

### TECHNICAL FIELD

The present disclosure relates to a method and apparatus for creating solutions for high complexity multidimensional scheduling problems in manufacturing environment, under a plurality of constraint types and execution-prohibiting events.

### BACKGROUND

Optimization problems are an integral part of life in general, and practically of any field, such as but not limited to business, manufacturing scheduling, planning optimal delivery routes between geographical locations (the “traveling salesman” problem), placement of circuits on a wafer in an electronic product, transportation, budget allocation, and many others.

An optimization problem is a problem of finding one or more solutions which are superior to all other feasible solutions.

The term “best” as related to a solution is tightly associated with the problem at hand, and may be comprised of an optimal value of a function related to a combination of multiple factors and in particular business goals, wherein some of which may be in conflict with each other. For example, in a process involving a high resource-consuming device, the term “best” can relate to on-time delivery while utilizing the device to the maximum.

Many of the optimization problems are known to be NP-hard problems, meaning that the number of possible solutions grows exponentially with the size of problem input, stated for example in terms of work orders, time slots, machines, raw material, operation steps, personnel, tools, production cycles, and general or specific/unique operational and business goals and constraints. Hence explicit or implicit exploration of all feasible solutions to guarantee an optimal solution is practically prohibitive, and may require computer time which exceeds the allowable planning time even by the fastest computer. Therefore, such optimization problems are often addressed by using heuristic methods and approximation algorithms that are expected to converge to feasible solutions which are better than other solutions at the specific point in time. For example, an optimal solution for a scheduling problem may change over time due to various factors, such that the optimal solution at a certain time may be different than the solution which is optimal for the same set of work orders on a following week.

Of specific interest are certain production stations in manufacturing floors that have exceptionally high capital costs and consume extreme operational costs when active. For example, in the manufacture of aviation components, full-size industrial autoclaves or ovens are used to handle parts by one or more operations, each defined by specific preprogrammed conditions, altogether termed “recipe”.

The high and ongoing costs thus necessitate that these stations are operated at maximum capacity in terms of fullness and proper scheduling. In addition, the operation of such devices needs to comply with multiple other constraints, including energy and other resources supply, geometrical constraints of the handled materials and parts, the structure of the devices, personnel and shipping constraints and others.

Additionally, manufacturing floors are ever-changing environments, where failures of all types may happen, such as a machine malfunctioning, an absent tool, raw material not arriving on time, a worker did not report to work, or the like. Thus, it is often required to adapt a planned schedule to the current conditions. It may also be necessary to make these changes as early as possible rather than at the last moment, as any unexpected event may lead to a series of changes on the planned schedule. For example, if the completion of a first order is a pre-requisite for starting the manufacturing process of other orders, any delay of the execution of the first order may delay the planned execution of the other orders. It may also be required to assign the resources that have become available to other tasks, in order to keep high level of resources utilization.

### BRIEF SUMMARY

One exemplary embodiment of the disclosed subject matter is a method for determining a scheduling for a manufacture environment, comprising: obtaining a work order where one or more parts are to undergo a recipe-driven process to be executed by a device, according to a recipe; obtaining the recipe upon which the recipe-driven process is to be executed; obtaining a plurality of constraints for the recipe-driven process associated with the work order, the plurality of constraints relating at least to an area or volume of the device and area or volume of the parts; generating a schedule for processing the parts by the recipe-driven process in accordance with the plurality of constraints; prior to execution of the recipe-driven process, receiving through an interface an automated notification of an event prohibiting execution of the recipe-driven process; and regenerating an updated schedule for preparing the work order, including the recipe-driven process. Within the method, the device is optionally an autoclave or an industrial oven. Within the method, the device is optionally a painting or dyeing station. Within the method, the device is optionally an item selected from the group consisting of: a 3D printing station, an injection molding machine, a CNC machine, a composite layup station, a laminating machine, a screen printing machine, a mixing or blending machines, a laser cutter, a wire bonding station, a pharmaceutical filling stations, and a PCB manufacturing station. Within the method, the automated notification is optionally received from the device. Within the method, the automated notification is optionally received from a freezer in which materials to be processed are stored. Within the method, at least one constraint from the plurality of constraints optionally relates to a size, shape or arrangement of the part relative to a size or shape of the device. Within the method, at least one constraint optionally relates to a size or shape of a container for receiving the at least one part, relative to a size or shape of the device. Within the method, at least one constraint optionally relates to personnel required at least for a start time or an end time of the recipe-driven process, or to a required tool. Within the method, the device is optionally an autoclave, and at least one constraint optionally relates to a number of available vacuum ports of the autoclave. Within the method, at least one constraint optionally relates to predetermined hours at which the recipe-driven process is to start or to a production cycle. Within the method, at least one constraint optionally relates to a token limitation of the device wherein each work order is associated with a number of tokens. Within the method, at least one part optionally comprises multiple parts that share the recipe, and the device is optionally an autoclave or an oven that can cure the multiple parts simultaneously. Within the method, the at least one part optionally comprises multiple parts that share the recipe, and the device is optionally an injection molding machine that can produce the multiple parts simultaneously, and wherein the recipe optionally includes identical material, temperature, pressure, tools, and cycle time. Within the method, the at least one part optionally comprises multiple parts that share the recipe, and the device is optionally a mixing or blending machine that can process multiple parts simultaneously, and wherein the recipe optionally includes identical ingredient ratios, mixing speed, temperature, and duration. Within the method, the at least one part optionally comprises multiple parts that share the recipe, the device is optionally a painting station, and the at least one constraint optionally relates to a combination of parts that need to be processed together at a same run of the painting station. Within the method, generating the schedule or regenerating the schedule is optionally based on Artificial Intelligence (AI) or machine learning (ML) algorithms. Within the method, regenerating the schedule by the AI or ML algorithms is optionally based on a plurality of pre-generated schedules. Within the method, generating or regenerating the schedule by the AI or ML algorithms is optionally based on a plurality of pre-generated schedules. Within the method, the AI algorithms optionally comprise a reinforcement learning (RL) algorithm configured to: evaluate a plurality of schedules generated by a scheduling engine; analyze strengths and weaknesses of each schedule with respect to time and resource allocation; and modify priorities within a demand set based on the analysis to optimize subsequent schedule generation. Within the method, modifying the priorities within the demand set optionally comprises: assigning rewards and punishments based on schedule performance metrics; adjusting relative priorities for time allocation of jobs; and adjusting relative priorities for resource allocation of jobs. Within the method, the RL algorithm is optionally configured to: identify a local optimum in a current schedule; execute a transition to explore an alternative schedule configuration based on the modified demand set; and evaluate the alternative schedule configuration for improved quality metrics. Within the method, analyzing the strengths and weaknesses comprises: evaluating resource utilization efficiency; evaluating adherence to temporal constraints; evaluating distribution of job priorities and jobs' due dates; and generating performance metrics for each evaluated aspect. Within the method, the RL algorithm optionally updates or utilizes a knowledge base retaining: historical schedule configurations; associated performance outcomes; successful priority modifications; common and specific business rules and constraints; and relationship patterns between demand set changes and schedule improvements. Within the method, modifying the priorities within the demand set optionally triggers the scheduling engine to: explore previously unexplored schedule configurations; apply modified job priorities in subsequent iterations; and generate new schedules incorporating the knowledge embedded in the modified demand set.

Another exemplary embodiment of the disclosed subject matter is a system having a processor, the processor being adapted to perform the steps of: obtaining a work order where at least one part is to undergo a recipe-driven process to be executed by a device, according to a recipe; obtaining the recipe upon which the recipe-driven process is to be executed; obtaining a plurality of constraints for the recipe-driven process associated with the work order, the plurality of constraints relating at least to an area or volume of the device and area or volume of the at least one part; generating a schedule for processing the at least one part by the recipe-driven process in accordance with the plurality of constraints; prior to execution of the recipe-driven process, receiving through an interface an automated notification of an event prohibiting execution of the recipe-driven process; and regenerating an updated schedule for preparing the work order, including the recipe-driven process.

Yet another exemplary embodiment of the disclosed subject matter is a computer program product comprising a non-transitory computer readable medium retaining program instructions, which instructions when read by a processor, cause the processor to perform: obtaining a work order where at least one part is to undergo a recipe-driven process to be executed by a device, according to a recipe; obtaining the recipe upon which the recipe-driven process is to be executed; obtaining a plurality of constraints for the recipe-driven process associated with the work order, the plurality of constraints relating at least to an area or volume of the device and area or volume of the at least one part; generating a schedule for processing the at least one part by the recipe-driven process in accordance with the plurality of constraints; prior to execution of the recipe-driven process, receiving through an interface an automated notification of an event prohibiting execution of the recipe-driven process; and regenerating an updated schedule for preparing the work order, including the recipe-driven process.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a recipe constraint of a recipe-driven device, in accordance with some exemplary embodiments of the disclosure.

FIGS. 2A-2E are schematic illustrations of area considerations in using devices, in accordance with some exemplary embodiments of the disclosure;

FIGS. 3A-3C are schematic illustrations of the usage of tools in devices, in accordance with some exemplary embodiments of the disclosure;

FIGS. 4A-4C are schematic illustrations of arrangements where items operated upon by a recipe-driven device require a vacuum port, in accordance with some exemplary embodiments of the disclosure;

FIGS. 5A-5C show a recipe-driven device with arrangements where the recipe (or physical needs) requires different number of people for handling the process, in accordance with some exemplary embodiments of the disclosure;

FIG. 6 is a flowchart of steps in a method for dynamically generating and updating a schedule, in accordance with some exemplary embodiments of the disclosure;

FIG. 7 is a flowchart of steps in a method for generating a schedule, in accordance with some exemplary embodiments of the disclosure;

FIG. 8 is a flowchart of steps in a method for detecting an unexpected situation and firing an event related to a problem in a recipe-driven device, in accordance with some exemplary embodiments of the disclosure;

FIG. 9 is a flowchart of steps in a method for detecting an unexpected situation and firing an event related to the availability of materials for executing a recipe, in accordance with some exemplary embodiments of the disclosure;

FIG. 10 is a flowchart of steps in a method for detecting an unexpected situation and firing an event related to proper storage of materials, in accordance with some exemplary embodiments of the disclosure;

FIG. 11 is a flowchart of steps in a method for regenerating a schedule upon receiving a prohibiting event, in accordance with some exemplary embodiments of the disclosure; and

FIG. 12 is a block diagram of the main entities in an apparatus for generating and updating a recipe-driven process, in accordance with some embodiments of the disclosure.

### DETAILED DESCRIPTION

One technical problem of the disclosure relates to planning a schedule and executing work orders according to the schedule in a manufacturing environment, where one or more recipe-driven processes are involved.

The term “recipe” as used in this disclosure is to be widely construed to cover one or more conditions which a component, some material(s), a piece, or a system needs to undergo as part of their preparation, such as one or more exposures to predetermined temperatures, chamber pressure or vacuum levels during operation, process duration, pressure, temperature, humidity levels, venting and drying conditions, or the like. A recipe may also comprise two or more stages, each requiring different conditions. It is appreciated that subject to meeting other constraints, parts that need to undergo the same recipe may be processed together, even if the parts are similar but not identical, or even different.

The term “recipe-driven process” as used in this disclosure is to be widely construed to cover any process or part thereof that requires an extraordinary device, for example a device that is rare, highly expensive to purchase and/or highly expensive to operate, and which the operation of requires a specific recipe including for example specific operation start time, space or shape limitations, or other constraints as detailed above.

The term “recipe-driven device” (also referred to as “device”) as used in this disclosure is to be widely construed to cover any device that is adapted to perform a recipe-driven process as above. Some examples of recipe-driven devices include large ovens for curing parts, autoclaves including full-size industrial ovens and autoclaves, dyeing or painting stations, 3D printing stations, injection molding machines, CNC machines, composite layup stations, laminating machines, screen printing machines, mixing or blending machines, laser cutting, wire bonding stations, pharmaceutical filling stations, PCB manufacturing stations, or the like. It is appreciated that a recipe-driven device can range from a simple device such as a paint station, to a highly complex and expensive device, such as an industrial oven or autoclave that consumes significant amounts of electricity. Multiple parts or pieces may be processed together by the same recipe-driven device only if they require the same recipe, and subject to other conditions, such as sufficient space within the device.

In one example, the recipe-driven device may be an autoclave, which may be capable of curing multiple parts simultaneously, as long as the parts require the exact same recipe.

In another example, the device may be an injection molding machine which can produce multiple parts simultaneously, provided the parts share the same recipe, such as identical material, temperature, pressure, and cycle time settings. This allows manufacturers to optimize machine utilization, reduce production time, and improve efficiency by molding different parts within the same batch.

In yet another example, the device may be a mixing or blending machine which can process multiple parts simultaneously as long as they share the same recipe such as identical ingredient ratios, mixing speed, temperature, and duration. This ensures uniformity in composition and consistency across all parts. In industries such as food, pharmaceuticals, and composites, this capability allows manufacturers to efficiently produce different items in a single batch, thereby maximizing machine utilization while maintaining quality and consistency.

Some such devices incur high capital costs and consume extreme operational costs when operated, wherein some of the costs are per activation, regardless of the operation time or number of consecutive operations. In some instances, the electrical needs of such an autoclave are also extremely high so as to be regulated by local bylaws to specific prescheduled dates or to nighttime, when the need can be met by the power company.

Considering the high capital and operational costs, these devices often constitute a bottleneck for a production process. Thus, optimizing and maximizing their utilization also drives overall higher throughput of the broader production operation. It is appreciated that the abovementioned conditions and constraints are in addition to those present in any production process, including personnel, raw material, shipping requirements, cleanliness, or the like.

Thus, one technical problem of the disclosure relates to scheduling the operation of recipe-driven devices according to the appropriate recipes with all associated conditions and constraints, at maximal capacity in terms of fullness and proper scheduling, in order to minimize and/or make the best use of the high operation costs needs. Such scheduling is generally a multi-dimensional problem that requires multi-dimensional solution, including aspects such as but not limited to human resources, materials, tools, physical dimensions, or the like.

Another technical problem of the disclosure relates to receiving automatic notifications from the recipe-driven devices or from other devices or systems associated with the process of an event that prohibits execution of the recipe-driven process, such as but not limited to a problem with the device, the raw material, personnel, auxiliary tools, or the like.

Yet another technical problem of the disclosure relates to having to adjust the schedule to the circumstances, for example regenerate a schedule that will meet the constraints, given the prohibiting event.

Yet another technical problem of the disclosure relates to scheduling and optionally rescheduling the processes as early as possible, when more options are still valid and more resources are still available, rather than wait for the last minute where flexibility is lower. It is appreciated that any unexpected event may lead to a series of changes of the plan, due to the multiple dependencies among orders and individual tasks. Any change to the plan may thus have wide implications on the resource assignments in different dimensions, such as but not limited to personnel, tools, machines, stations and materials resources. Using current solutions, buffers are added to a manual plan to reserve time for fixing the plan in response to unexpected events. However, dynamic updating and rescheduling following changes on the production floor are required enable to eliminate such buffers.

One technical solution provided by the disclosure relates to a system and method for generating a multi-dimensional solution for a recipe-driven process, given a set comprising a plurality, for example hundreds to hundreds of thousands work orders, the recipes and multiple constraints in multiple dimensions, as detailed below. The solution uses dynamic AI-based techniques which consider all relevant production elements and constraints in real-time or near real time, to automatically generate optimized and practical plans.

In some embodiments, a plurality of schedules having high scores of meeting business goals and operational rules, and complying with constraints may be generated on an ongoing basis. For example, tens, hundreds, or thousands of schedules may be generated every predetermined period of time, such as every week based on the latest demand set.

For example, if 100 schedules are generated every week, after one year about five thousand schedules are collected, making up a robust and validated dataset for the factory. The scheduled dataset may be complemented by an executed schedule results dataset, indicating which, when and how work orders have been performed, which unexpected events have occurred and how the schedules have been changed, or the like.

It is appreciated that the valid schedules are generated at higher speeds than human schedulers are capable of. Initially, such schedules can also be local optimum peaks which are not high-quality schedules.

Once schedules are generated, further schedules may be generated or regenerated, for example in response to detected events. The schedules may be generated for example by using Artificial Intelligence (AI) or Machine Learning (ML) algorithms. In some embodiments, the algorithms may comprise a reinforcement learning (RL) algorithm configured to: evaluate a plurality of schedules generated by a scheduling engine; analyze strengths and weaknesses of each schedule with respect to time and resource allocation; and modify priorities within the demand set based on the analysis, to optimize subsequent schedule generation. Modifying the priorities within the demand set may comprise assigning rewards and punishments based on schedule performance metrics; adjusting relative priorities for time allocation of jobs; and adjusting relative priorities for resource allocation of jobs in order to verify a desired balance between work orders, to minimize delays and gaps between work orders' due dates and actual delivery date. The RL algorithm may also be configured to identify a local optimum in a current schedule; execute a transition to explore an alternative schedule configuration based on the modified demand set; and evaluate the alternative schedule configuration for improved quality metrics. Analyzing the strengths and weaknesses may be performed by evaluating resource utilization efficiency; evaluating adherence to temporal constraints; evaluating distribution of job priorities and jobs' due dates; and generating performance metrics for each evaluated aspect. The RL algorithm may utilizes and optionally update a knowledge base retaining: historical schedule configurations; associated performance outcomes; successful priority modifications; common and specific business rules and constraints, or relationship patterns between demand set changes and schedule improvements. Modifying the priorities within the demand set may trigger the scheduling engine to: explore previously unexplored schedule configurations; apply modified job priorities in subsequent iterations; or generate new schedules incorporating the knowledge embedded in the modified demand set.

Thus, the knowledge embedded in the demand set for future iterations may be used for significantly improving the suggested schedule. This is a unlike current techniques, which mostly apply micro-steps restricted to the “neighborhoods” of current local peaks. This difference enables a breakthrough in scale and performance for fully automatic manufacturing scheduling in complex organizations.

The datasets may be segmented and analyzed, incorporating key metrics such as weekly machine utilization, raw material consumption, and task duration, thereby creating a comprehensive, high-quality dataset for the factory, which can be utilized by machine learning driven optimizations. The datasets thereby enable continuous improvement of the machine learning algorithms for generating further improved schedules.

The solution provides for obtaining a valid practical schedule that is better than schedules produced using other solutions, and enables, if possible, to meet the business goals including for example the completion of work orders, while complying with the constraints.

Another technical solution provided by the disclosure provides for the system and method to receive notifications or indications about external events which are triggered through one or more hardware components such as sensors, RFID receivers, machine controllers, or the like, that are in communication with a scheduling system, wherein such events may prohibit the execution of the schedule. The notifications may be received in real time or near real time via interfaces with one or more of the hardware components. For example, a notification may be received from the recipe-driven device itself that a problem exists, whether the problem strictly halts any operation of the device or necessitates certain changes; from a station where the raw material to be processed is expected; from a human resources management system, or the like.

Another technical solution provided by the disclosure provides for regenerating the schedule subsequent to receiving the notification, and doing so immediately, for example in real time or near real time after receiving the notification, to avoid missing options and eliminate buffer times between tasks. The new schedule needs to comply with the same or different constraints. For example, a different machine may have to be used; an intended delivery is missed and it is required to wait for the next delivery, a shift of the personnel changed and an operator with the required skill cannot be there when the device is expected to finish its operation as required, or the like.

One technical effect of the disclosure provides for generating, using for example algorithms and machine learning, a schedule for meeting business goals while complying with the constraints.

The schedule takes into account business rules which have to be complied with, and elements for which tradeoffs needs to be taken into account, such as due date compliance percentage, work order priority, physical resource constraints, and overall machine utilization. Thus, the schedule needs to consider the potential tradeoffs and align production processes with the business goals and cost control.

Employing advanced algorithms and machine learning, the solution schedules tasks, predicts, and mitigates potential issues, thus enhancing task scheduling, reducing production costs, and boosting overall plant efficiency and productivity.

Specifically, the schedule optimizes the utilization of recipe-driven devices and thus additional parameters such as the overall costs of the operation. The solution particularly addresses the operational challenges of critical stations such as autoclaves or special ovens. It optimizes operations, reduces costs, and improves sustainability and predictability. The solution also optimizes the lead time of the manufactured parts. By making the most out of each recipe-driven station run, the production floor may produce more parts on a given time period. In some examples, an improvement of up to 50% in the lead time of the manufacturing process, 15% increase in throughput and 20% increase in predictability of the task completion has been measured. In one example an increase from 75% to 95% in delivering according to their commitments has been measured.

This solution significantly surpasses existing market solutions by integrating a wide array of factors in scheduling and task assignment.

Another technical effect of the disclosure provides for receiving in real time or near real time notifications to malfunctions or other events inhibiting execution of the schedules, such that the schedule may be regenerated, for example in response to each such notification, in accordance with the new conditions.

The early notifications, for example in real time or near real time provide for responding dynamically to resource availability, capacity changes and other events, and thereby offer greater flexibility, due to the availability of more scheduling options as compared to receiving the notifications at a later time, for example when operation of the recipe-driven device is to be started or has already started. It is appreciated that the dynamic response improves the performance and the cost effectiveness of the process.

While the human brain cannot take into consideration all the restrictions and requirements, including static and dynamic ones while scheduling, the disclosed solution provides a dynamic AI-based solution that considers all relevant production elements in real-time or near real time to automatically generate optimized and practical plans.

Another technical effect of the disclosure provides for eliminating the time buffers which are added to any manual plan, and is intended to reserve time for rescheduling should any unexpected events happen. Eliminating the buffers increases the utilization of the recipe-driven devices, shortens down time and thus increases the efficiency of the manufacturing environment.

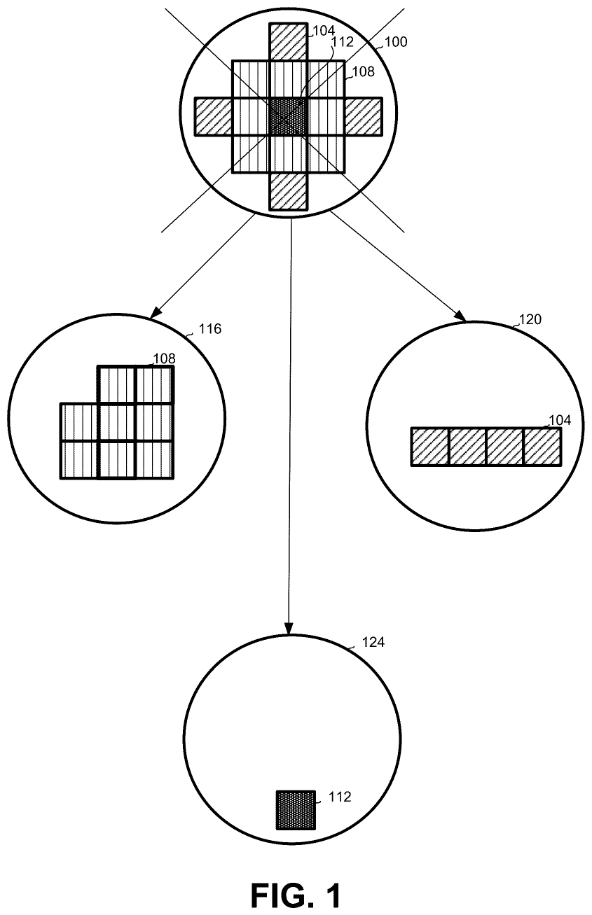

Referring now to FIGS. 1-5C, demonstrating common constraints applicable to recipe-driven devices and processes, in accordance with some exemplary embodiments of the disclosure.

FIG. 1 provides a schematic illustration of a recipe constraint of a recipe-driven device such as an autoclave, in accordance with some exemplary embodiments of the disclosure.

FIG. 1 shows a situation where items or parts requiring different recipes are to be treated in a recipe-driven device, for example an autoclave.

The items include four items of type 104, eight items of type 108, and one item of type 112. Each type requires a different recipe, for example, different temperatures, different durations, different tension levels, different combination of the above, or the like.

Therefore, although area-wise all thirteen (13) items can fit in one autoclave run using arrangement 100, this is unfeasible, and the items of each type need to be handled separately.

Therefore, despite the great waste of device-space, the autoclave may be run three times, once with arrangement 116 in which the eight items of type 108 are arranged, a second time with arrangement 120 in which the four items of type 104 are arranged, and third run with arrangement 124 in which the item of type 112 is arranged. The runs may be ordered according to delivery dates, urgency, cost efficiency, priority or other business goals or considerations as detailed below.

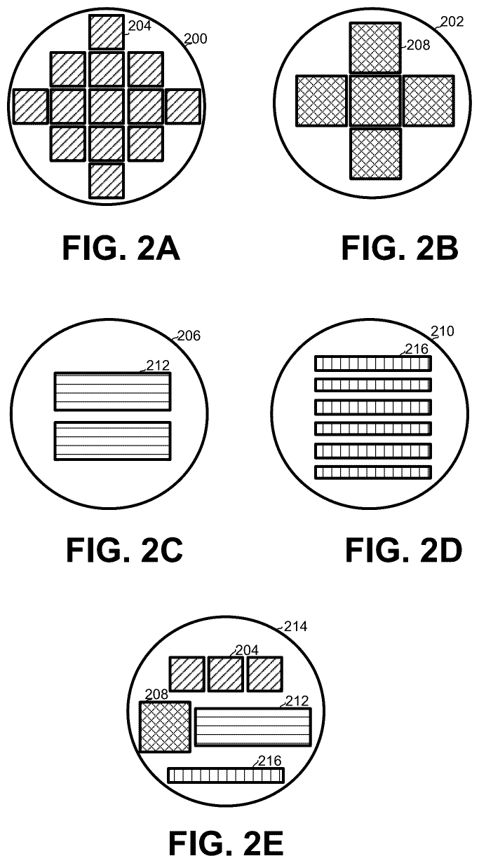

Referring now to FIGS. 2A-2E, showing schematic illustrations of area considerations in using devices such as autoclaves, in accordance with some exemplary embodiments of the disclosure.

FIGS. 2A-2D show possible arrangement of items of a same type, wherein the arrangement aims to place as many items as possible into the autoclave, in order to minimize the required number of activations.

Thus, arrangement 200 shows thirteen items of type 204 arranged for a single run, arrangement 202 shows five items of type 208 arranged for a single run, arrangement 206 shows two items of type 212 arranged for a single run, and arrangement 210 shows six items of type 216 arranged for a single run.

FIG. 2E shows arrangement 214 of three items of type 204, and one item of each of types 208, 212 and 216.

It is appreciated that even if area-wise items of different types can be processed together in a single run, this is subject to all items requiring the exact same recipe.

It is also appreciated that processing items of the same type or of different types may be subject to additional constraints as detailed below, so unless all constraints are complied with, and the items require the same recipe, items of different types cannot be handled together.

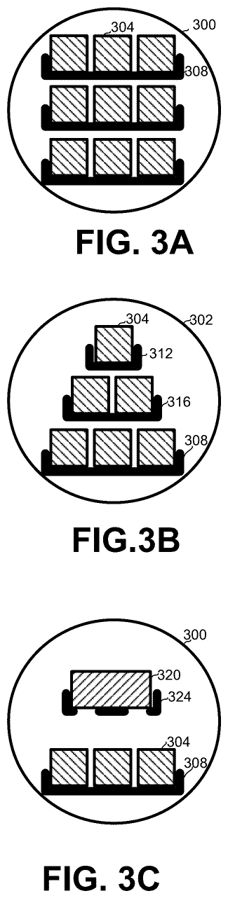

Referring now to FIGS. 3A-3C showing schematic illustrations of the usage of tools in devices, in accordance with some exemplary embodiments of the disclosure.

Often, items cannot be placed freely in recipe-driven devices but must be placed within specific tools, such as pans or molds. In such situations, the area constraints relate to the size of the molds, regardless of the mold occupancy, and not to the size or arrangement of the handled items.

FIG. 3A shows arrangement 300 comprising three identical molds 308, each holding three items of type 304, altogether handling nine items.

However, if fewer than nine items are to be handled, FIG. 3B shows arrangement 302 of molds of three different sizes, mold 312 holding one item of type 304, mold 316 holding two items of type 304, and mold 308 holding three items of type 304. It is appreciated that other arrangements may also be used, such as two molds of type 308.

FIG. 3C shows arrangement 306, holding molds of two different sizes, wherein each mold is designed to hold items of different types. Thus, arrangement 306 comprises mold 324 designed to hold a single item of type 320, and mold 308 holding three items of type 304.

As mentioned above, the feasibility of arrangement 306 is subject to items of types 320 and 304 requiring the exact same recipe, and complying with other constraints, if applicable.

Yet another type of constraint frequent in devices such as autoclaves relates to vacuum ports.

In an autoclave, the number of items placed within the device needs to correspond to the number of vacuum ports present at the device, such that each item is connected directly or indirectly to a vacuum port of the device, for example to ensure adequate removal of air, gas, or other particles, and thus successful sterilization. The number of vacuum ports therefore is an example of a limiting factor, related to optimal flowthrough in a workstation, that should be considered when planning an optimal workstation schedule.

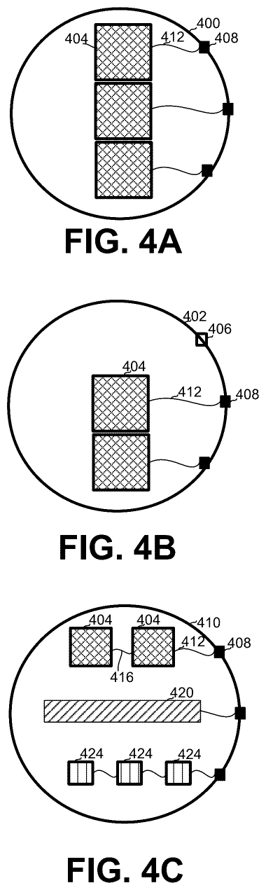

Referring now to FIGS. 4A-4C, showing schematic illustrations of arrangements where items operated upon by a recipe-driven device require a vacuum port, in accordance with some exemplary embodiments of the disclosure.

FIG. 4A shows arrangement 400 having three items of type 404, wherein each such item needs and has a direct connection 412 to a vacuum port 408.

FIG. 4B depicts a situation of arrangement 420, where vacuum port 406 is out of order and thus, only two items of type 404 can be handled on each run. Thus, the schedule needs to be regenerated and a third item of type 404 may need to be processed on a separate run, thereby reducing the throughput of the device and possibly harming the delivery of the work orders.

FIG. 4C shows an arrangement 410 where some items connect directly to a vacuum port while others connect indirectly. Indirect connection may refer to “daisy chaining”, e.g. connecting a single vacuum port to multiple outlets in a sequence, in order to achieve vacuum pressure in multiple ports. Thus, arrangement 410 comprises two items of type 404, wherein a first item connects directly through connection 412 to vacuum port 408, while a second item connects indirectly to vacuum port 408 through connection 416 to the first item. Whether an item can be connected indirectly to a vacuum port may be defined as part of the type definition.

Arrangement 410 further comprises one item of item type 420 connected directly to a vacuum port, and three items of type 424, where one of the items connects directly to a vacuum port, while the other two items connect indirectly.

As above, the concurrent processing of items of different types within the same device is subject to the respective recipes being identical, and to meeting other applicable constraints.

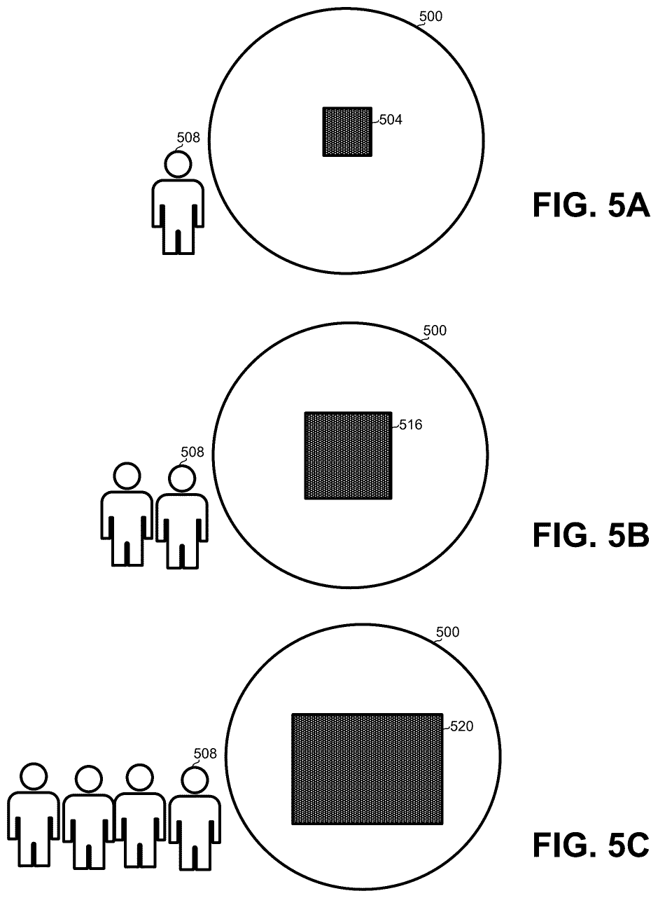

Referring now to FIGS. 5A-5C, showing constraints associated with personnel required for operating a recipe-driven device, in accordance with some exemplary embodiments of the disclosure.

FIGS. 5A-5C show, respectively, a recipe-driven device with arrangements where the recipe (or physical needs) requires, respectively, one, two and four people for handling the process, in accordance with some exemplary embodiments of the disclosure.

The number of personnel members may be determined upon the size or weight of the manufactured parts or manipulated materials, upon regulations, or the like. In some situations, personnel members are required to be present at the beginning and/or at the end of the operation, while in other situations they may be required to be at the site throughout the operation. In some cases, a minimal and maximal number of operators required for an operation may be defined, in which case the optimal number of operators may be selected for performing the task at a given time, considering all other orders that need to be performed.

Thus, schedules that require personnel need to be adjusted to the availability of the operators, including taking into account the possibility for overtime if required, human resources regulations which may inhibit a worker to be present for more than a predetermined number of hours, or the like.

Another type of constraint relates to situations where fixed running cycles are exercised, for example, cycles may be regularly run at 8AM, 11AM, 3PM and 6PM. The cycle times may or may not be synchronized or otherwise associated with the employee shifts. In some situations, the running time may be associated with the energy prices at the time, for example it may be attempted to first utilize the off-peak hours when electricity is cheaper. The fixed timetables may provide stability, efficiency, predictability, and improved planning capabilities in production processes, which may be beneficial for achieving optimal performance and meeting customer demands. However, it may also eliminate flexibility and workarounds.

It is appreciated that the constraints detailed above are exemplary only, and that a different collection of constraints may be applicable to different environments. However, the solution may be adaptable to any such environment.

The term “token” may relate to a unit of measure used to represent and aggregate multiple types of constraints simultaneously, including but not limited to: physical dimensions and in particular volume, weight, length, resource capacity, regulatory compliance requirements, and specialized processing conditions.

In some situations, the cost of each run of a recipe-driven device, such as a curing device, is significant and relatively fixed, organizations may like to avoid underutilizing the device, such as an autoclave. Therefore, reducing the number of cures and making more effective use of the capacity for each cure has the potential to significantly reduce the overall cost of producing the parts, increase the throughput capacity of the plant, improve sustainability, and reduce costs.

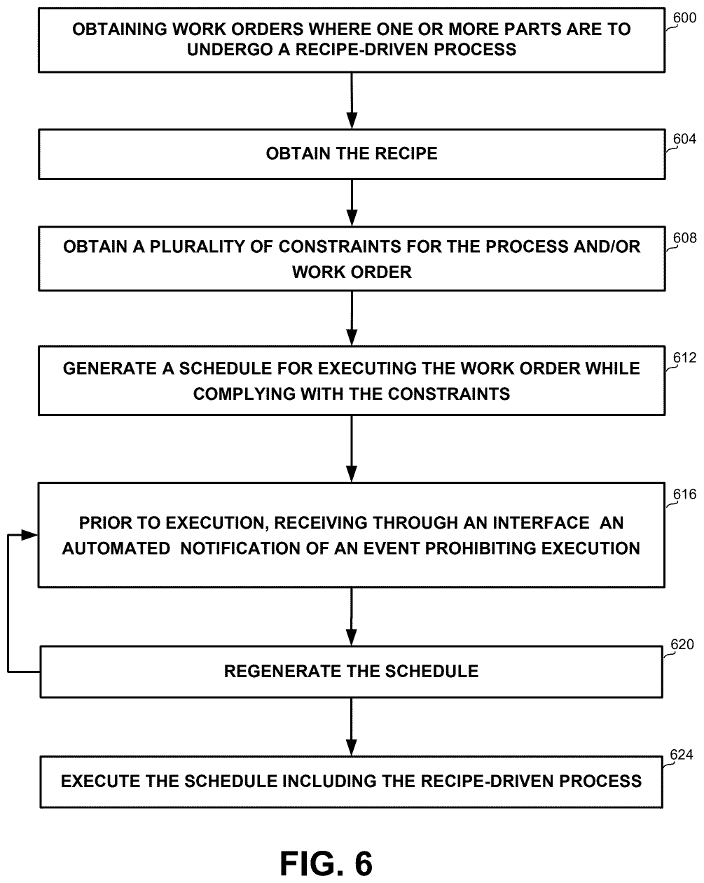

Token usage is an effective tool for optimize device and other critical resources capacity utilization. In some exemplary embodiments, each resource, such as an autoclave, is assigned during configuration a predetermined number of tokens. The quota is then filled, on schedule generation steps 612 or 620 of FIG. 6, with items of a predefined token contribution. For example. an autoclave defined with a capacity of 2000 tokens can be filled with: 8 items each contributing 250 tokens; 10 items, each contributing 200 tokens; an item contributing 500 tokens, along with additional items that contribute 1500 tokens altogether.

It is appreciated that token units and constraints may be used for aggregating a plurality of constraints, and may also be used in conjunction with other constraints as detailed above.

It is appreciated that the token-enabled system provides for unified handling of multiple constraint types through a single numerical representation, while maintaining compliance with other constrains as detailed above.

Another type of constraint relates to tasks which are not performed by the manufacturer but rather outsourced. When scheduling jobs that require outsourcing, such as painting or printing, the departure and return times of the items associated with these tasks need to be synchronized with the tasks that need to be completed before and after the externally performed task. In this case, jobs that can be ready for departure at the designated time and can seamlessly continue with subsequent tasks upon their return to the factory may be prioritized over jobs that cannot

Thus, a schedule for completing a given collection of work orders needs to comply with all the constraints, restrictions, requirements, capacities and availabilities of the related resources, and follow the business rules and their priorities, while meeting the due dates and optimizing the tradeoff between the business goals.

Referring now to FIG. 6, showing a flowchart of steps in a method for dynamically generating and updating a schedule, in accordance with some exemplary embodiments of the disclosure.

At step 600, one or more work orders may be received, in which one or more parts need to undergo a recipe-driven process, for example curing in an autoclave. The work orders may be retrieved from a database, read from a file, entered by a human, received over a communication channel, or obtained in any other manner.

Each work order may include at least the type or types of parts to be handled, the quantity, the due date or time, or the like.

At step 604, the recipe (or a reference thereto) upon which the work order or a step thereof is to be executed, may be obtained. The recipe may indicate the device by which the part or parts may be manipulated, required temperature, pressure, duration, personnel, vacuum ports and connections, and/or any other relevant parameters. The recipe may also be retrieved from a database, read from a file, entered by a human, received over a communication channel, or obtained in any other manner.

At step 608, a plurality of constraints may be obtained, such as but not limited to the size(s) of the parts to be processed, the size of the device, wherein sizes may relate to the shape or to any one or more dimensions; the used tools such as molds or pans and their sizes, shapes and capacity; the available vacuum ports or other utilities of the device; the available manpower and constraints related thereto, such as shift duration or overtime limitations, or the like. It is appreciated that the constraints detailed above are exemplary only, and any other set of constraints may be applied. All or at least a plurality of these constraints are typically present at complex production environments, and thus need to be handled at the same time. It is appreciated that the large number of constraints does not enable efficient manual scheduling, not obtaining an efficient solution generation by traditional techniques. In some situations, some of the constraints may be irrelevant, for example the part combination or layout of parts to be processed in an autoclave may be given as part of the process definition, such that only the other constraints need to be considered.

At step 612, a schedule may be generated which meets the requirements for executing the work orders, while complying with the constraints, and in particular that only materials or parts subject to the same recipe are handled together.

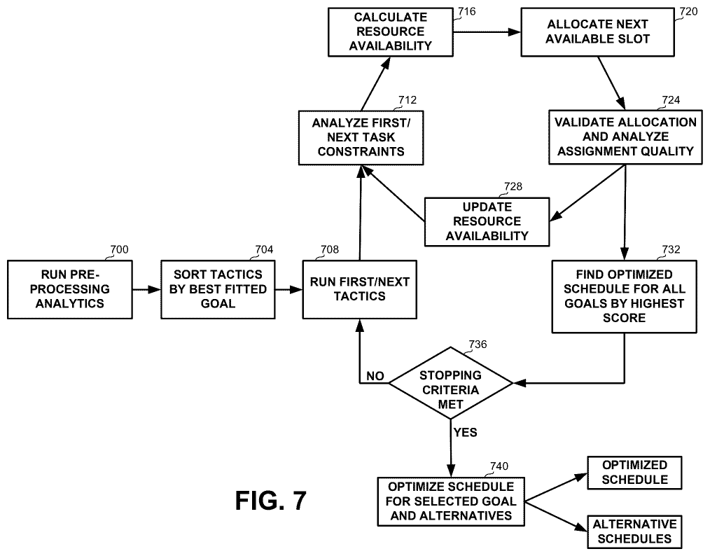

Referring now also to FIG. 7, showing a flowchart of steps in a method for generating a schedule, in accordance with some exemplary embodiments of the disclosure.

At step 700, pre-processing analytics may be executed upon the data collected at steps 600, 604 and 608 of FIG. 6, including the work orders, the recipes and the constraints. Pre-processing may include preparing the information for scheduling. Pre-processing may include preparing the bill of process, which may comprise determining the specific tasks from the work orders, i.e., the specific actions each work order includes; the functionality dependency between the tasks; the tool types required for each task; the business goal, e.g., deliver all work orders as soon as possible, maximize device utilization, minimize resource usage, or the like; the available resources of each type and how it may be used including manpower, skill and shift factors, or the like.

In some embodiments, the demand set, e.g., the work orders and/or the tasks may be ordered in association with the business goals, for example, according to parameters such as their priority, urgency, the benefit of delivering them early, their duration and/or resource consumption, or the like. Entities such as tasks and business goals such as but not limited to: maximizing due date compliance, maximizing overall utilization, maximizing recipe-driven station utilization, maximizing scheduled tasks, minimizing make-span may be assigned weights and/or priorities for determining their precedence.

At step 704, the available tactics, also referred to as the algorithms used for scheduling, may be sorted in accordance with the best fitted goal. In some examples, forward and backward scheduling may be considered. For example, in forward scheduling, a task with an early delivery date/time may be scheduled, and then another, until a dead end is reached, for example a task that cannot be fitted, in which case the algorithm reverts one or more assignments and tries a different assignment. The selection of how to assign tasks to devices, tools, personnel and others may utilize the assigned weights and/or priorities, the business goals, and other entities and factors.

Thus, at step 704, the tactics are mapped and sorted in accordance with the business goals and the demand set, which provides a starting point for exploring the solution space which comprises a tremendous number of schedules. For example, backward scheduling may prove more effective when a leading goal is resource utilization.

Step 704 may utilize artificial intelligence (AI) techniques and in particular machine learning, for example, learning from past schedules the probability of unexpected events, the schedules that have been updated to accommodate for the events, or the like. Learning may be based upon a plurality of schedules prepared ahead, following their execution and changes and deriving better schedules, as detailed above.

At step 708, the best tactic (or the next best tactic in further iterations) may be executed as detailed below.

Execution for a task in the demand set may start at step 712 where the task constraints are analyzed. For example, whether all pre-required tasks are scheduled to be completed, whether the task can be completed timely, or the like.

At step 716 it may be analyzed whether all required resources, tools and personnel are available and at step 720, the task may be allocated to a certain time slot, with all required resources, such as device, tools, personnel or other requirements. It is appreciated that a loop may occur between step 716 and 720, in case not all resources are ready at a certain time slot.

At step 724, the assignment may be analyzed, and its quality may be assessed. For example, it may be determined how vulnerable the task execution is, such as whether its completion is closer to the deadline than a predetermined threshold, whether one device is assigned significantly more work than a similar device, to what extent business goals are met, or the like.

It is appreciated that steps 720 and 724 may also be performed using AI and ML techniques.

At step 728 the resource availability may be updated, in accordance with the resource usage planned for the current task.

Execution may then return to step 712 for assigning a further task. In some embodiments, the assignment of all tasks by each tactic may be repeated a plurality of times and may generate a plurality of schedules, by selecting different weights as determined at step 700, prioritizing the business goals differently, or the like.

At step 732, when all tasks are assigned, the optimized schedule may be selected from the schedules suggested by the tactic, for example according to compliance with the business goals. The optimized schedule may be determined by assigning a score to each schedule suggested by the tactic, and selecting the schedule with the highest score.

At step 736, it may be determined whether a stopping criterion is met. A stopping criterion may be that a predetermined computation time exceeded, that in the last predetermined period of time the improvement in the quality of the acquired schedules has not increased or has increased in less than a predetermined value, all tactics and relevant weights have been executed, or the like. If the stopping criteria has not been met, execution may return to step 708 for executing a further tactic which was assigned a lower score at step 704, or an already tried tactic with different weights or priorities, according to the weights and priorities as sorted at step 704.

If the stopping criteria has been met, then at step 740 the highest score schedule may be selected for the selected business goal or the business goal with the highest priority. The schedule may be fine-tuned or optimized, and the optimized schedule may be output, for example stored, sent to a person in charge, activated automatically, or the like.

Additionally, the highest score relevant for other business goals may be selected, optimized, and output. Thus, in case of a change in the business goals, in the ranking of a business goal, or in another factor, another scheduling may be assigned a higher score for the same demand set, and may thus be selected. Thus, optimized schedules for multiple scenarios are determined in advance and can be selected instantaneously, such that no further calculations are required.

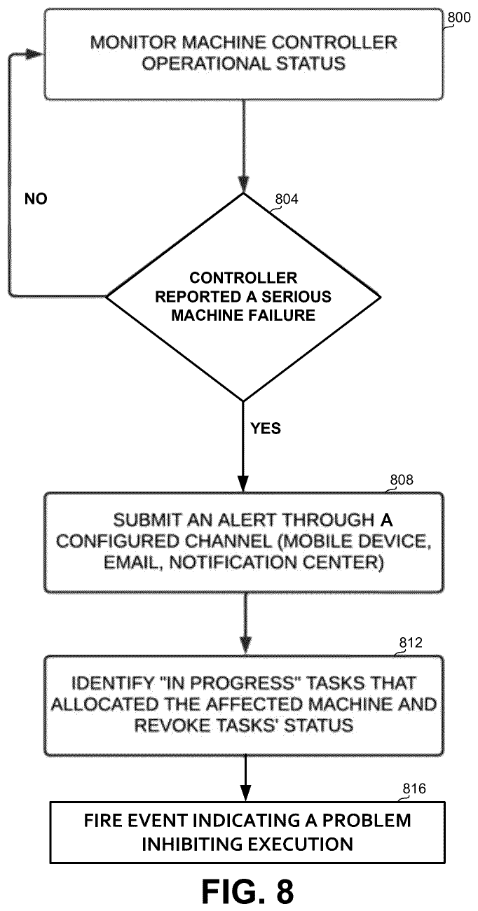

Referring now back to FIG. 6, at step 616, prior to the beginning of an execution of a device-driven process of the schedule, such as starting an autoclave operation, an automated notification may be received through an interface. The interface may be realized in hardware, software, firmware, a communication channel, of the like. The notification may be received from any device or system associated with any device or component associated with the manufacturing floor. The device may relate to an unexpected event that inhibits the activation. The notification may be received automatically from an automated system, as detailed in association with FIGS. 8-10 below.

Referring now also to FIG. 8, showing a flowchart of steps in a method for detecting an unexpected situation and firing an event related to a problem in a recipe-driven device, in accordance with some exemplary embodiments of the disclosure.

At ongoing step 800, the machine controller may be monitored for the operational status of the recipe-driven device. The machine controller provides real time or near real time indications to the status, and therefore can provide immediate indication to any identified problem.

At step 804 it may be checked whether the controller reported a failure in the machine.

Optionally, it may be determined whether the failure is minor and whether the device is operative or not. If the problem is minor, an action may be taken, such as sending an alert to a person in charge, updating a database, or the like.

If there is no problem, or if a minor problem has been identified, execution may continue in monitoring step 800.

If there is a critical problem, then at step 808 an alert may be submitted through a predetermined channel, such as sending a message to one or more predetermined mobile devices, sending an e-mail, updating a notification center, or the like.

At step 812, tasks, e.g., work orders or steps thereof which are currently in progress and that will require the recipe-driven device are identified, optionally together with their status. The status may indicate, for example, when the device will be needed for the work order, whether the work order can be delayed or is urgent, or the like.

At step 816, an event indicating a problem that inhibits usage of the device, with or without the status, may be fired, for example sent to a computing device in charge of generating and maintaining schedules.

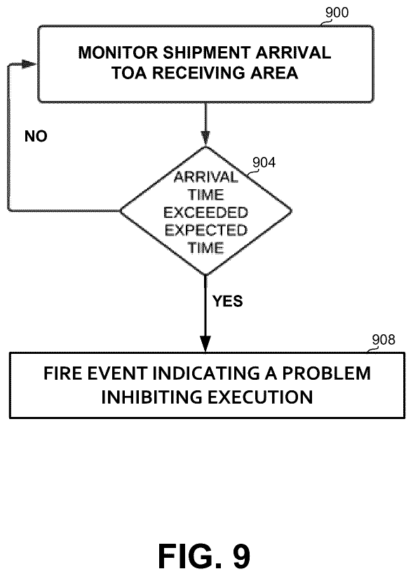

Referring now also to FIG. 9, showing a flowchart of steps in a method for detecting an unexpected situation and firing an event related to the availability of materials for executing a recipe, in accordance with some exemplary embodiments of the disclosure.

At ongoing step 900, the arrival of a shipment to a receiving area within the environment may be monitored. In some exemplary embodiments, the monitoring may be performed by monitoring a status updated upon reading a radio frequency identification (RFID) tag attached to a shipment.

At step 904, it may be determined whether the arrival time exceeded the expected arrival time, for example if the shipment arrived at a time that will not enable to prepare it for processing by the recipe-driven device, or the shipment has not arrived at all by the time it is supposed to enter processing. If the time has not exceeded yet, monitoring may continue at step 900.

Otherwise, if the time exceeded such that the materials or parts cannot be processed as required, at step 908 an event may be fired, indicating a problem with the material, that inhibits execution. Firing the event may be implemented by sending a notification to a computing device in charge of generating and maintaining schedules. Additionally, a notification may be provided to another system, to a person in charge, or the like, in any of the manners detailed above.

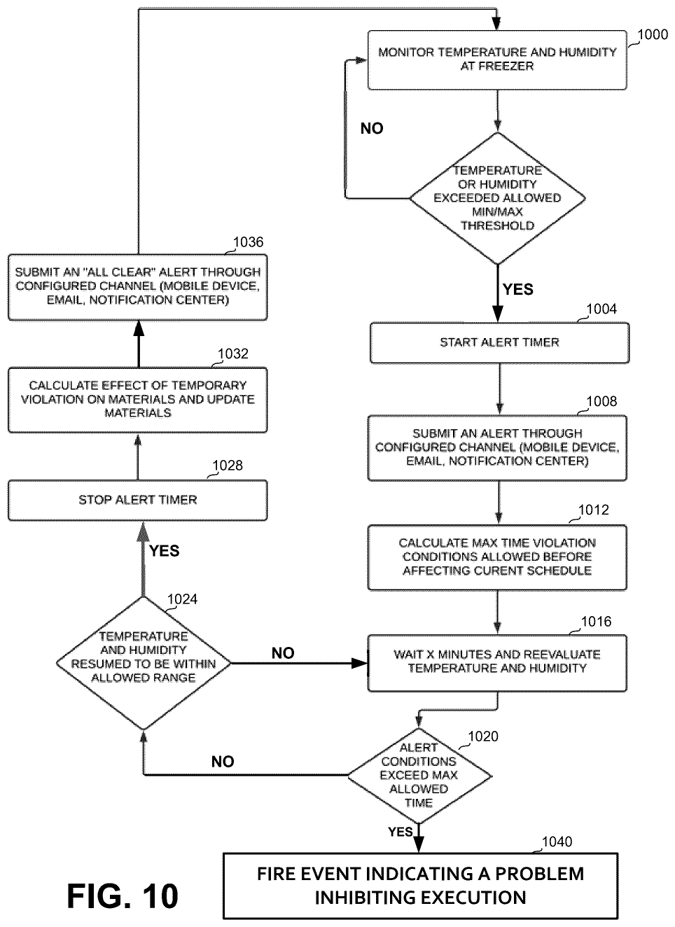

Referring now also to FIG. 10, showing a flowchart of steps in a method for detecting an unexpected situation and firing an event related to proper storage of materials, in accordance with some exemplary embodiments of the disclosure.

Proper storage may relate to certain conditions that the material should be maintained at, such as temperature, pressure, humidity, light, or the like. Although the example below relates to temperature or humidity in a freezer, it is apparent that the disclosure is equally applicable, mutatis mutandis, to other monitored conditions.

At step 1000, the temperature and/or humidity (hereinafter “conditions”) in a monitored freezer, where materials required to be processed are stored.

Monitoring step 1000 may be repeated as long as the conditions do not exceed allowed minimal and/or maximal thresholds.

Once the conditions deviate from the allowed range, at step 1004 an alert timer may be set.

At step 1008, an alert may be submitted through a predetermined channel, such as sending a message to one or more predetermined mobile devices, sending an e-mail, updating a notification center, or the like.

At step 1012, a maximal allowed duration may be calculated for the conditions to exceed the thresholds before the materials are damaged in a way that prohibits processing or usage. The calculation may take into account the properties of the materials, whether and how much the conditions in which the materials have been stored previously deviated from the threshold as calculated at step 1032 below, or the like. In some embodiments, the maximal allowed duration may be expressed as a function rather than a number, for example a function integrating the deviation from the range and their impact on the materials or parts.

At step 1016 the conditions may be further evaluated, for example after a predetermined period of time.

At step 1020, it may be determined whether the allowed maximal duration has been exceeded, in accordance with the elapsed time or the function detailed above.

If the allowed maximal duration has not been exceeded, it may be determined at step 1024 whether the conditions have returned to not exceeding the threshold.

If the conditions have resumed, then at step 1028 the alert timer set at step 1004 may be stopped.

Additionally, if the acceptable conditions have resumed, at step 1032 the effect of the temporary condition violation may be calculated and stored in association with other information related to the materials. For example, if a second violation occurs, the period of time calculated at step 1012 may be shorter than in the first time.

At step 1036 a clearance alert may be submitted through the configured channel as above, and execution may return to step 1004 for ongoing monitoring of the conditions.

However, if it is determined at step 1020 that the condition deviation has exceeded the threshold, then at step 1040 an event indicating a problem with the materials, which inhibits execution of the recipe-driven process may be fired.

Referring now back to FIG. 6. Once an event prohibiting execution is received, at step 620 a schedule may be regenerated, which takes into account the execution-prohibiting event, and which optimizes execution of the work orders in accordance with the recipes and the various constraints.

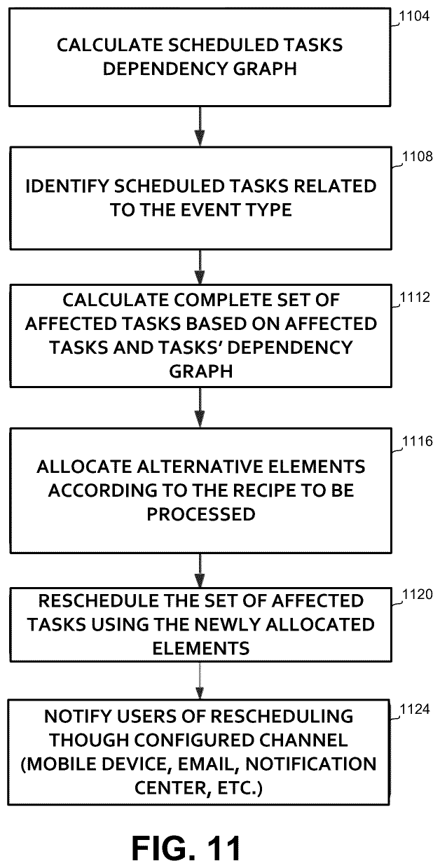

Referring now also to FIG. 11, showing a flowchart of steps in a method for regenerating a schedule upon receiving a prohibiting event, in accordance with some exemplary embodiments of the disclosure.

At step 1104, a dependency graph of the scheduled tasks may be generated. The graph may be generated in any desired manner, such as Breadth First Search (BFS), Depth First Search (DFS), or the like, based on all outstanding work orders, on all outstanding orders having any association to the failed factor that initiated the event, such as shared devices, shared materials, materials stored together, production floor, personnel, or the like.

At step 1108, scheduled tasks related to the event type may be identified.

For example, in the case of device failure (FIG. 8), the tasks requiring the failed machine may be identified.

In the delayed shipment example (FIG. 9), the tasks that involve materials that should have been in the delayed shipment are identified.

In the improper storage conditions example (FIG. 10), the tasks that involve materials that have been in the failed freezer are identified.

At step 1112, the complete set of affected tasks may be created, for example as a unification of the affected tasks determined at step 1108 and the tasks appearing in the dependency graph of the failed tasks, as determined at step 1104.

At step 1116, alternatives may be allocated for the missing or defected parts, raw material, devices, personnel, or other elements of the recipe-driven process.

For example, in the device failure case, an alternative device, such as an autoclave, may be allocated to replace the failed machine according to the required recipe, subject to the new machine meeting all mandatory operational and business criteria defined in the manufacturing process for the intended part.

In the delayed shipment or improper storage conditions examples, substitute materials may be allocated instead of the materials that did not arrive timely, or are unusable due to improper storing conditions. The materials may differ to some degree from the originally allocated ones, but constitute a proper replacement.

At step 1120, the complete set of affected tasks, as determined at step 1112 may be rescheduled using the newly allocated resources, such as the newly allocated devices in the case of device failure or the newly allocated materials in the case of the late shipment or improper storing conditions.

Scheduling can be performed in the same manner as the original scheduling, as detailed in association with FIG. 7 above.

At step 1124, a user may be notified about the newly projected schedule, through a predetermined channel, such as by sending a message to one or more predetermined mobile devices, sending an e-mail, updating a notification center, or the like.

Referring now back to FIG. 6, once the new schedule is generated, and no new execution-prohibiting event is received, the new schedule including the recipe-driven processes may be executed as planned at step 624.

Steps 616 and 620 may repeat until execution starts without further prohibiting events. Then, at step 624, the recipe-driven process may be executed.

The method may be repeated for further parts, or further processes, as required to complete the work orders.

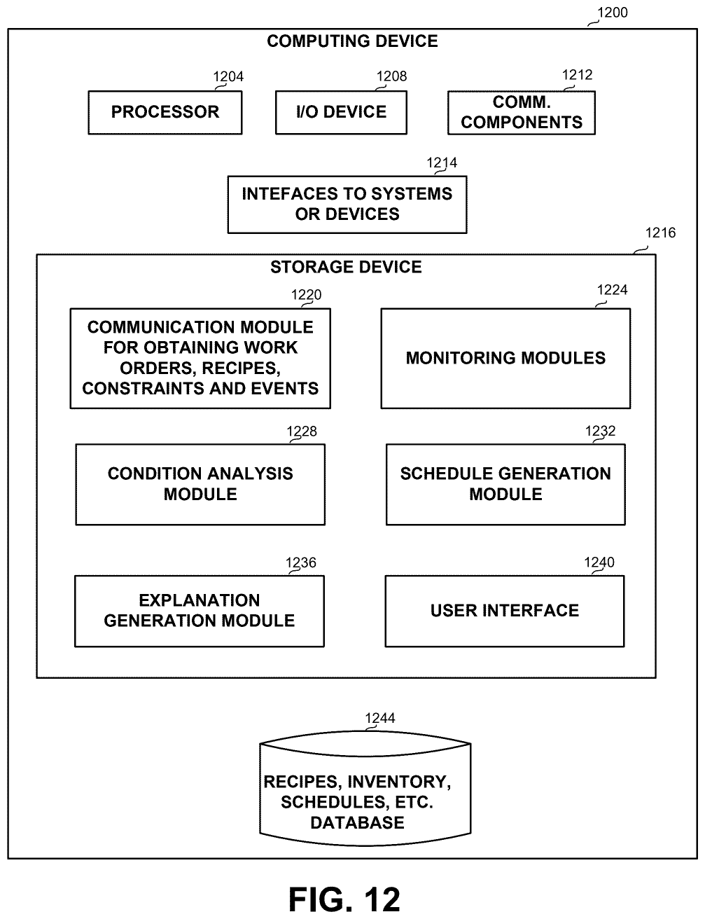

Referring now to FIG. 12, showing a block diagram of the main entities in an apparatus for generating and updating a recipe-driven process, in accordance with some embodiments of the disclosure.

The system may comprise one or more computing platforms 1200. In some embodiments, computing platform 1200 may comprise one or more operatively connected computing platforms, whether collocated on-site, remote, or a combination thereof. For example, one or more computing platforms 1200 may be in the Cloud or a computer system on organization premises, and may provide services to one or more clients, such as one or more computing platforms associated with one or more organizations. One or more computing platforms 1200 may be a part of a computer network of the organization. In other embodiments, all the functionality may be provided by one or more computing platforms all being a part of the organization network.

Computing platform 1200 may comprise one or more processors 1204, which may be one or more Central Processing Units (CPU), microprocessors, electronic circuits, Integrated Circuits (IC) or the like. Processor 1204 may be configured to provide the required functionality, for example by loading to memory and activating the software modules stored on storage device 1216 detailed below.

Computing platform 1200 may comprise Input/Output (I/O) device 1208 such as a display device, a speakerphone, a headset, a keyboard, a pointing device, a touch screen, or the like. I/O device 1208 may be utilized to receive input from and provide output to a user, for example receive instructions from the user, display suggested schedules to the user, receive manipulation instructions from the user and display the schedules as manipulated.

Computing platform 1200 may comprise one or more communication components 1212, for communicating with other systems or components, such as shipment handling systems, ERP (Enterprise Resource Planning) system, device controllers, inventory systems, human resources management system, or the like. Communication components 1212 may also communicate with other computing platforms, whether co-located or remote. Communication components 1212 may enable communication through multiple channels and multiple protocols, such as Local Area Network (LAN), Wide Area Network (WAN), intranet, Internet, cellular, Wi-Fi, Bluetooth™, or the like.

Computing platform 1200 may comprise one or more interfaces 1214 to other systems or devices on the manufacturing floor or associated therewith, for receiving notifications of unexpected events.

The Interfaces may be realized in hardware, software (for example as modules in storage device 1216 detailed below), firmware, through any communication component 1212, or the like.

Computing platform 1200 may comprise a storage device 1216, such as a hard disk drive, a Flash disk, a Random Access Memory (RAM), a memory chip, or the like. In some exemplary embodiments, Storage device 1216 may retain program code operative to cause processor 1204 to perform acts associated with any of the modules listed below, or steps of the methods disclosed above. The program code may comprise one or more executable units, such as functions, libraries, standalone programs or the like, adapted to execute instructions as detailed below.

Storage device 1216 may retain or be in operative communication with one or more communication modules 1220, for communicating with external computing platforms or systems, such as inventory management systems, deice controllers, or the like. Communication modules 1220 may be operative in obtaining work orders, recipes, inventory levels, constraints, and events such as execution prohibiting events. The communication may utilize any one or more of communication components 1212.

Storage device 1216 may retain or be in operative communication with one or more monitoring modules 1224 for monitoring one or more devices or systems, such as freezers, controllers of recipe-driven devices for reporting device health, or the like.

Storage device 1216 may retain or be in operative communication with condition analysis module 1228 for assessing whether received events or other information may impact an existing schedule, for example whether a problem in a freezer may make some materials unusable, whether a problem in a device is critical, or the like.

Storage device 1216 may retain or be in operative communication with schedule generation module 1232, for generating a schedule based upon known conditions, such as the outstanding work orders, existing devices and materials, constraints, due dates, or the like. Schedule generation is further detailed in association with FIG. 7 above.

Storage device 1216 may retain or be in operative communication with explanation generation module 1236, for generating a user-comprehensible explanation to a schedule, or why a schedule was changed, for example “device X1 has two broken vacuum ports, therefore part Y1 is handled by device Z and part Y2 is handled by device W”.

Storage device 1216 may retain or be in operative communication with user interface 1240 for receiving input from a user, such as amendments to schedules or related limitations, and for displaying information to a user, such as a generated schedule, an explanation to a schedule or to a change, as generated by explanation generation module 1236, or the like. User interface 1240 may utilize any one or more of I/O devices 1208.

Storage device 1216 may retain or be in operative communication with one or more databases 1244, which may store recipes, inventory information, schedules, operator skills, maintenance procedures, parts bill of materials (BOM), bill of processes (BOP), shift configurations, tools, and other information required for managing production.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determining a scheduling for a manufacture environment, comprising:
obtaining a work order where at least one part is to undergo a recipe-driven process to be executed by a device, according to a recipe;
obtaining the recipe upon which the recipe-driven process is to be executed;
obtaining a plurality of constraints for the recipe-driven process associated with the work order, the plurality of constraints relating at least to an area or volume of the device and area or volume of the at least one part;
generating a schedule for processing the at least one part by the recipe-driven process in accordance with the plurality of constraints;
prior to execution of the recipe-driven process, receiving through an interface an automated notification of an event prohibiting execution of the recipe-driven process; and
regenerating the schedule for preparing the work order, including the recipe-driven process.

2. The method of claim 1, wherein the device is an autoclave or an industrial oven.

3. The method of claim 1, wherein the device is a painting or dyeing station.

4. The method of claim 1, wherein the device is at least one item selected from the group consisting of: a 3D printing station, an injection molding machine, a CNC machine, a composite layup station, a laminating machine, a screen printing machine, a mixing or blending machines, a laser cutter, a wire bonding station, a pharmaceutical filling stations, and a PCB manufacturing station.

5. The method of claim 1, wherein the automated notification is received from the device.

6. The method of claim 1, wherein the automated notification is received from a freezer in which materials to be processed are stored.

7. The method of claim 1, wherein at least one constraint from the plurality of constraints relates to a size, shape or arrangement of the part relative to a size or shape of the device.

8. The method of claim 1, wherein at least one constraint from the plurality of constraints relates to a size or shape of a container for receiving the at least one part, relative to a size or shape of the device.

9. The method of claim 1, wherein at least one constraint from the plurality of constraints relates to personnel required at least for a start time or an end time of the recipe-driven process, or to a required tool.

10. The method of claim 1, wherein the device is an autoclave and the at least one constraint from the plurality of constraints relates to a number of available vacuum ports of the autoclave.

11. The method of claim 1, wherein at least one constraint from the plurality of constraints relates to predetermined hours at which the recipe-driven process is to start or to a production cycle.

12. The method of claim 1, wherein at least one constraint from the plurality of constraints relates to a token limitation of the device wherein each work order is associated with a number of tokens.

13. The method of claim 1, wherein the at least one part comprises multiple parts that share the recipe, and wherein the device is an autoclave or an oven that can cure the multiple parts simultaneously.

14. The method of claim 1, wherein the at least one part comprises multiple parts that share the recipe, and wherein the device is an injection molding machine that can produce the multiple parts simultaneously, wherein the recipe includes identical material, temperature, pressure, and cycle time.

15. The method of claim 1, wherein the at least one part comprises multiple parts that share the recipe, and wherein the device is a mixing or blending machine that can process multiple parts simultaneously wherein the recipe includes identical ingredient ratios, mixing speed, temperature, and duration.

16. The method of claim 1, wherein the at least one part comprises multiple parts that share the recipe, wherein the device is a painting station, and wherein the at least one constraint from the plurality of constraints relates to a combination of parts that need to be processed together at a same run of the painting station.

17. The method of claim 1, wherein generating the schedule or regenerating the schedule is based on Artificial Intelligence (AI) or machine learning (ML) algorithms.

18. The method of claim 17, wherein generating or regenerating the schedule by the AI or ML algorithms is based on a plurality of pre-generated schedules.

19. The method of claim 17, wherein the AI algorithms comprise a reinforcement learning (RL) algorithm configured to:
evaluate a plurality of schedules generated by a scheduling engine;
analyze strengths and weaknesses of each schedule with respect to time and resource allocation; and
modify priorities within a demand set based on the analysis to optimize subsequent schedule generation.

20. The method of claim 19, wherein modifying the priorities within the demand set comprises:
assigning rewards and punishments based on schedule performance metrics;
adjusting relative priorities for time allocation of jobs; and
adjusting relative priorities for resource allocation of jobs.

21. The method of claim 19, wherein the RL algorithm is configured to:
identify a local optimum in a current schedule;
execute a transition to explore an alternative schedule configuration based on the modified demand set; and
evaluate the alternative schedule configuration for improved quality metrics.

22. The method of claim 19, wherein analyzing the strengths and weaknesses comprises:
evaluating resource utilization efficiency;
evaluating adherence to temporal constraints;
evaluating distribution of job priorities and jobs' due dates; and
generating performance metrics for each evaluated aspect.

23. The method of claim 19, wherein the RL algorithm utilizes a knowledge base retaining:
historical schedule configurations;
associated performance outcomes;
successful priority modifications;
common and specific business rules and constraints; and
relationship patterns between demand set changes and schedule improvements.

24. The method of claim 19, wherein modifying the priorities within the demand set triggers the scheduling engine to:
explore previously unexplored schedule configurations;
apply modified job priorities in subsequent iterations; and
generate new schedules incorporating the knowledge embedded in the modified demand set.

25. A system having a processor, the processor being adapted to perform the steps of:
obtaining a work order where at least one part is to undergo a recipe-driven process to be executed by a device, according to a recipe;
obtaining the recipe upon which the recipe-driven process is to be executed;
obtaining a plurality of constraints for the recipe-driven process associated with the work order, the plurality of constraints relating at least to an area or volume of the device and area or volume of the at least one part;
generating a schedule for processing the at least one part by the recipe-driven process in accordance with the plurality of constraints;
prior to execution of the recipe-driven process, receiving through an interface an automated notification of an event prohibiting execution of the recipe-driven process; and
regenerating an updated schedule for preparing the work order, including the recipe-driven process.

26. A computer program product comprising a non-transitory computer readable medium retaining program instructions, which instructions when read by a processor, cause the processor to perform: obtaining a work order where at least one part is to undergo a recipe-driven process to be executed by a device, according to a recipe;
obtaining the recipe upon which the recipe-driven process is to be executed;
obtaining a plurality of constraints for the recipe-driven process associated with the work order, the plurality of constraints relating at least to an area or volume of the device and area or volume of the at least one part;
generating a schedule for processing the at least one part by the recipe-driven process in accordance with the plurality of constraints;
prior to execution of the recipe-driven process, receiving through an interface an automated notification of an event prohibiting execution of the recipe-driven process; and
regenerating an updated schedule for preparing the work order, including the recipe-driven process.
